(19) United States
(12) Patent Application Publication
(10) Pub. No.: US 2012/0308712 A1
(43) Pub. Date: Dec. 6, 2012

(54) GREEN TEA BEVERAGE PACKED IN A CONTAINER

(75) Inventors: Masami Sasame, Makinohara-shi (JP); Keisuke Numata, Makinohara-shi (JP); Fuyuki Fujihara, Makinohara-shi (JP); Kazunobu Tsuru, Makinohara-shi (JP)

(73) Assignee: ITO EN, LTD., Tokyo (JP)

(21) Appl. No.: 13/575,806

(22) PCT Filed: Dec. 22, 2010
(86) PCT No.: PCT/JP2010/073105

§ 371 Date: Jul. 27, 2012

(30) Foreign Application Priority Data
Jan. 29, 2010 (JP) 2010-019136

(51) Int. Cl. A23F 3/38; A23F 3/16

(52) U.S. Cl. 426/597

(57) ABSTRACT

Provided is a caffeine-reduced green tea beverage packed in a container which can be enjoyed either hot or cold, and which has a sense of being concentrated due to its roasted aroma, and which has an astringent richness, while at the same time being refreshing. The green tea beverage packed in a container has a caffeine concentration of less than 90 ppm, and a total sugar concentration (obtained by adding the concentration of nonreducing sugars and the concentration of reducing sugars) that falls within the range of 100 ppm to 300 ppm; a ratio of the concentration of nonreducing sugars to the concentration of reducing sugars (non-reducing sugars/reducing sugars) that falls within the range of 13.0 to 23.0, and a ratio of ester catechins to sugar concentration (ester catechins/sugars) that falls within the range of 0.4 to 1.1.

### TECHNICAL FIELD

The present invention relates to a green tea beverage packed in a container that contains an extraction liquid of a green tea, which is extracted from green tea leaves as a major component and is filled into a plastic bottle or a can or the like.

### BACKGROUND ART

A green tea beverage is drunk not only to quench the thirst, but in recent years, from the viewpoint of advance of health on the focus of physiological actions of catechins or the like contained in a green tea.

However, a green tea beverage contains caffeine, which is known to have excitatory action or the like, and cause headache, insomnia or the like. Particularly, in the case where a green tea beverage is ingested by infants, old people, pregnant women or the like, there may be a concern of influence of caffeine on them.

Therefore, a green tea beverage having reduced content of caffeine attracts attention in recent years.

For example, Patent Document 1 discloses a tea beverage, which is characterized by containing tannin and caffeine, and having the ratio of the tannin content/the caffeine content being 30 or more.

Patent Document 2 discloses a beverage, which contains (A) an ester type catechin, (B) a free type catechin, and (C) caffeine, wherein the contents are:

(A)+(B)=500 to 6000 mg (I)

(A)/[(A)+(B)]=0.7 to 1.0 (II)

(A)/(C)=6 to 27. (III)

Patent Document 3 discloses a food and drink, which is characterized by containing caffeine in an amount of 0.1 weight part or less, and containing cyclo dextrin in an amount of 0.1 to 20.0 weight parts with respect to 1 weight part of catechins.

### CITATION LIST

### Patent Document

Patent Document 1: Japanese Patent Application Laid-Open (JP-A) No. 2008-113569
Patent Document 2: JP-A No. 2006-67828
Patent Document 3: JP-A No. 10-4919

### DISCLOSURE OF THE INVENTION

### Problem to be Solved by the Invention

Under the circumstances where a green tea beverage packed in a container has been popularized, the present inventors earnestly studied a beverage that has unique taste and aroma. As a result, the present inventors found out that adjustments to certain conditions of the concentration of sugars which is a sum of the concentration of monosaccharides and the concentration of disaccharides, and the ratio of the concentration of disaccharides relative to the concentration of monosaccharides, provide a beverage packaged in a container that has refreshing aftertaste, and strong fire odor (savory odor), and has no light taste of the beverage packed in a container (Japanese Patent Application No. 2009-47419). On the other hand, in recent years, along with diversification of drink scene or the like, low caffeine tea beverage was demanded. However, if the content of caffeine is reduced, there is a problem that components involved in bitter astringent taste are reduced, and concentration feeling is barely sensed.

The present inventors further earnestly studied, and found out that by mainly adjusting the ratio of ester type catechins relative to the concentration of sugars in a beverage, it is possible to adjust a balance of astringent taste and sweet taste, and it is possible to provide a beverage that has concentration feeling from fire odor (savory odor), and has richness of astringent taste and refreshing taste even when caffeine is reduced in a green tea beverage packed in a container.

Therefore, the present invention provides a caffeine amount-reduced green tea beverage packed in a container that has concentration feeling from fire odor, and has richness of astringent taste, and refreshing taste, and particularly can be drunk delectably even in a cold state.

### Means for Solving Problem

The green tea beverage packed in a container of the present invention is characterized by having the concentration of caffeine being less than 90 ppm; the concentration of sugars which is a sum of the concentration of reducing sugars and the concentration of non-reducing sugars, being 100 ppm to 300 ppm; the ratio of the concentration of non-reducing sugars relative to the concentration of reducing sugars (non-reducing sugars/reducing sugars) being 13.0 to 23.0; and the ratio of the concentration of ester type catechins relative to the concentration of sugars (ester type catechins/sugars) being 0.4 to 1.1.

As described above, adjustments of the concentration of sugars which is a sum of the concentration of reducing sugars and the concentration of non-reducing sugars, the concentration ratio of reducing sugars and non-reducing sugars, and the concentration ratio of sugars and ester type catechins, allow a green tea beverage packed in a container that has concentration feeling from fire odor (savory odor), and has richness of astringent taste, and refreshing taste, and particularly can be drunk delectably even in a cold state even with a low amount of the concentration of caffeine being less than 90 ppm.

### BEST MODE(S) FOR CARRYING OUT THE INVENTION

Hereinafter, one illustrative embodiment of the green tea beverage packed in a container of the present invention will be explained. However, the present invention is not limited to this illustrative embodiment.

The present green tea beverage packed in a container is a beverage obtained by filling a liquid containing an extraction liquid or an extract that is obtained by extraction of a green tea as a major component, into a container. The liquid includes, for example, a liquid that comprises only an extraction liquid that is obtained by extraction of a green tea, or a liquid obtained by dilution of the extraction liquid, or a liquid obtained by mixing of the tea extraction liquids with each other, or a liquid obtained by addition of an additive to any of the above-mentioned liquids, or a liquid obtained by dispersion of those dried of any of the above-mentioned liquids and the like.

The “major component” encompasses a meaning that containing of other components is acceptable within a range of not impeding the functions of the major component. At this time, the content ratio of the major component is not specified, but an extraction liquid or an extract that is obtained by extraction of a green tea, preferably takes up 50% by mass or more, particularly 70% by mass or more, and particularly 80% by mass or more (including 100%) in the solid content concentration in the beverage.

In addition, the kind of the green tea is not particularly limited. For example, the kind of the green tea includes broadly teas that are classified as a non-fermented tea such as a steamed tea, a decocted tea, a refined green tea, a green powdered tea, a Bancha tea, a bead green tea, an oven-roasted tea, a Chinese green tea, and also encompasses a blend thereof in two kinds or more. In addition, cereals such as a brown rice, a flavor such as jasmine may be also added thereto.

One illustrative embodiment of the green tea beverage packed in a container of the present invention (referred to as “the present green tea beverage packed in a container”) is characterized by having the concentration of caffeine being less than 90 ppm; the concentration of sugars which is a sum of the concentration of non-reducing sugars and the concentration of reducing sugars being 100 ppm to 300 ppm; the ratio of the concentration of non-reducing sugars relative to the concentration of reducing sugars (non-reducing sugars/reducing sugars) being 13.0 to 23.0; and the ratio of the concentration of ester type catechins relative to the concentration of sugars (ester type catechins/sugars) being 0.4 to 1.1.

The reducing sugar is a sugar that shows reducing character, and forms an aldehyde group and a ketone group in an alkaline solution. The reducing sugar referred to in the present invention is glucose, fructose, cellobiose or maltose.

The non-reducing sugar is a sugar that does not show reducing character, and the non-reducing sugar referred to in the present invention represents sucrose, stachyose, or raffinose.

The concentration of sugars which is a sum of reducing sugars and non-reducing sugars (hereinafter, referred to as the concentration of sugars.), being 100 ppm to 300 ppm, allows a refreshing beverage that has sweet taste and richness taste, and has a balance of aroma and taste remaining in the aftertaste being maintained, and also has concentration feeling from fire odor, and has small bitter taste in the aftertaste, and has richness.

From such viewpoint, the concentration of sugars is preferably 120 ppm to 280 ppm, particularly preferably 140 ppm to 240 ppm.

In adjustment of the concentration of sugars to the above-described range, dry (firing) process or extraction of tea leaves may be adjusted to suitable conditions. For example, if dry (firing) process of tea leaves is performed strongly, sugars are decomposed and decrease. In addition, if the tea leaves are extracted at high temperature for a long time, the sugars are decomposed and decrease. Therefore, the concentration of sugars may be adjusted by dry (firing) conditions and extraction conditions of tea leaves.

Although the adjustment may be performed by addition of sugars, this has a fear of collapse of the original flavor balance of a green tea beverage, so the adjustment is preferably not by addition of sugars, but by adjustment of conditions for obtaining a tea extraction liquid, and in addition, by mixing of the tea extraction liquids with each other, or by addition of a tea extract, or the like.

In addition, when the ratio of the concentration of non-reducing sugars relative to the concentration of reducing sugars (non-reducing sugars/reducing sugars) is 13.0 to 23.0, it allows a drink that has top aroma note and aroma remaining in the aftertaste when the green tea beverage is put into the mouth, and has no bitter taste, senses concentration feeling from aroma, and robust feel.

From such viewpoint, the ratio of the concentration of non-reducing sugars relative to the concentration of reducing sugars (non-reducing sugars/reducing sugars) is preferably 15.0 to 22.0, and particularly preferably 17.0 to 22.0.

In adjustment of the ratio of the concentration of non-reducing sugars relative to the concentration of reducing sugars to the above-described range, dry (firing) process or extraction of tea leaves may be adjusted to suitable conditions. For example, if dry (firing) process of tea leaves is performed, reducing sugars decrease first, and then non-reducing sugars decrease. Thus, by strongly performing dry (firing) process of tea leaves and extracting the tea leaves at high temperature for a short time, it is possible to elevate the value of non-reducing sugars/reducing sugars. Although the adjustment may be performed by addition of sugars, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of total catechins in the present green tea beverage packed in a container is preferably 130 ppm to 660 ppm.

The concentration of total catechins is more preferably 180 ppm to 600 ppm, and particularly preferably 300 ppm to 400 ppm.

Furthermore, if the concentration of catechins is too high, a balance of aroma and taste collapses, so in the case where the aroma is particularly important, the concentration of total catechins is preferably 450 ppm or less, particularly 400 ppm or less.

At this time, the total catechins mean total eight kinds of catechins (C), gallocatechins (GC), catechins gallate (Cg), gallocatechins gallate (GCg), epicatechins (EC), epigallocatechins (EGC), epicatechins gallate (ECg), and epigallocatechins gallate (EGCg), and the concentration of the total catechins mean total values of the concentrations of the 8 kind catechins.

In adjustment of the concentration of total catechins to the above-described range, the concentration of total catechins may be adjusted by selection of raw materials, extraction conditions, or the like. Although the adjustment may be performed by addition of catechins, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of ester type catechins in the present green tea beverage packed in a container is preferably 40 ppm to 330 ppm.

The concentration of ester type catechins is more preferably 90 ppm to 245 ppm, and particularly preferably 110 ppm to 240 ppm.

Furthermore, the “ester type catechins” means total four kinds of epigallocatechins gallate (EGCg), gallocatechins gallate (GCg), epicatechins gallate (ECg), and catechins gallate (Cg).

In adjustment of the concentration of ester type catechins to the above-described range, the concentration of ester type catechins may be adjusted by selection of raw materials, extraction conditions, or the like. However, if the temperature is too high, or the extraction time is too long, it is not preferable in view of holding scent balance of a beverage. Although the adjustment may be performed by addition of ester type catechins, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The ratio of the concentration of ester type catechins relative to the concentration of sugars (ester type catechins/sugars) in the present green tea beverage packed in a container is 0.4 to 1.1.

When the ratio is within this range, it allows a beverage that has a balance of sweet taste and astringent taste, gives better sense of aroma remaining in the aftertaste, and has moderate richness and concentration feeling even under a low amount of caffeine, good cleanness, and good aftertaste, and allows a refreshing beverage that has an excellent balance of taste and aroma, and has excellent taste particularly when drunk at a low temperature.

From such viewpoint, the ratio of the concentration of ester type catechins relative to the concentration of sugars (ester type catechins/sugars) is preferably 0.6 to 1.0, and particularly preferably 0.7 to 0.9.

In adjustment of the ratio of the concentration of ester type catechins relative to the concentration of sugars to the above-described range, extraction conditions or the like may be adjusted. However, although the extraction rate of catechins increases at high temperature, sugars are likely to be decomposed in high temperature state, and thus the extraction time is preferably short. Although the adjustment may be performed by addition of ester type catechins and sugars, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The ratio of the concentration of sugars relative to the concentration of theanine (sugars/theanine) in the present green tea beverage packed in a container is preferably 5.0 to 50.0. When the ratio is within this range, it allows residual delicious taste, and good aroma.

Furthermore, the theanine is a derivative of glutamic acid contained in a green tea or the like, and includes, for example, L- or D-glutamic acid-γ-alkyl amide such as L-glutamic acid-γ-ethyl amide (L-theanine), L-glutamic acid-γ-methyl amide, D-glutamic acid-γ-ethyl amide (D-theanine), D-glutamic acid-γ-methyl amide, or a derivative containing the L- or D-glutamic acid-γ-alkyl amide in the basic structure (for example, glycoside of L- or D-glutamic acid-γ-alkyl amide and the like), and the like.

In adjustment of the ratio of the concentration of sugars relative to the concentration of theanine to the above-described range, the ratio may be adjusted with selection of raw materials and strong dry conditions for raw materials. Although the adjustment may be performed by addition of sugars and theanine, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of caffeine in the present green tea beverage packed in a container is less than 90 ppm.

Caffeine is generally contained in 110 ppm to 250 ppm in a conventional green tea beverage packed in a container. However, the caffeine amount of less than 90 ppm alleviates a physiological influence on a person.

From view of such viewpoint and the flavor, the concentration of caffeine is preferably 5 ppm to 85 ppm, and particularly preferably 10 ppm to 70 ppm.

In adjustment of the concentration of caffeine to the above-described range, the concentration of caffeine may be adjusted by blowing hot water to tea leaves, or immersing tea leaves in hot water to elute caffeine in the tea leaves, and prepare tea extraction liquids using the tea leaves, and mix the tea extraction liquids with each other. In addition, the extraction liquid may be subjected to an adsorbent such as activated carbon and white clay, whereby to adsorb and remove caffeine.

In addition, the ratio of the concentration of total catechins relative to the concentration of caffeine in the present green tea beverage packed in a container (total catechins/caffeine) is preferably 1.4 to 660.

The ratio of the concentration of total catechins relative to the concentration of caffeine is more preferably 2.0 to 350, and particularly preferably 4.0 to 200.

In adjustment of the ratio of the concentration of total catechins relative to the concentration of caffeine to the above-described range, the ratio may be adjusted with the above-described caffeine reducing treatment, the amount of tea leaves, and extraction temperature. Although the adjustment may be performed by addition of total catechins, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of the soluble solid content derived from the tea leaves in the present green tea beverage packed in a container is preferably 0.15 to 0.40%. Furthermore, the soluble solid content derived from the tea leaves refers to a sucrose-converted value of the soluble solid content obtained by extraction of the green tea leaves.

The concentration of the soluble solid content derived from the tea leaves in the present green tea beverage packed in a container is more preferably 0.16 to 0.37%, and particularly preferably 0.17 to 0.35%.

In adjustment of the concentration of the soluble solid content derived from the tea leaves to the above-described range, the concentration of the soluble solid content derived from the tea leaves may be suitably adjusted with the amount of tea leaves and extraction conditions.

The ratio of the concentration of sugars relative to the concentration of the soluble solid content derived from tea leaves (sugars/(the soluble solid content derived from the tea leaves×100)) in the present green tea beverage packed in a container is preferably 2.5 to 15.0. The ratio of the concentration of sugars relative to the concentration of the soluble solid content derived from tea leaves is more preferably 3.0 to 13.0, and particularly preferably 5.0 to 10.0.

In adjustment of the ratio of the concentration of sugars relative to the soluble solid content derived from tea leaves to the above-described range, the solid content concentration may be elevated by increasing the amount of tea leaves, and the ratio may be adjusted with dry conditions for the raw tea. Although the adjustment may be armed by addition of the sugars, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The pH in the present green tea beverage packed in a container is preferably 5.5 to 6.5 at 20° C. The pH in the present green tea beverage packed in a container is more preferably 5.8 to 6.4, and particularly preferably 5.9 to 6.3.

In adjustment of the pH to the above-described range, for example, the pH may be adjusted with the amount of a pH adjusting agent such as ascorbic acid and sodium bicarbonate.

The concentration of the above-described reducing sugars, non-reducing sugars, total catechins, ester type catechins, caffeine, and theanine, can be measured by a calibration curve method or the like using high performance liquid chromatogram (HPLC) or the like, and the concentration of the soluble solid content derived from tea leaves described above can be measured by a differential concentration meter.

(Container)

A container to be filled with the present green tea beverage packed in a container is not particularly limited. For example, a plastic-made bottle (so-called PET bottle), a can of metal such as steel and aluminum, a bottle, a paper container may be used, and particularly, a transparent container such as a PET bottle may be preferably used as the container.

(Manufacturing Method)

The present green tea beverage packed in a container may be manufactured by, for example, selecting raw materials for tea leaves; suitably adjusting conditions for dry (firing) process and extraction for the tea leaves; adjusting the concentration of caffeine in a beverage to less than 90 ppm; adjusting the concentration of sugars which is a sum of the concentration of non-reducing sugars and the concentration of reducing sugars, to 100 ppm to 300 ppm; adjusting the ratio of the concentration of non-reducing sugars relative to the concentration of reducing sugars (non-reducing sugars/reducing sugars) to 13.0 to 23.0; and adjusting the ratio of the concentration of ester type catechins relative to the concentration of sugars (ester type catechins/sugars) to 0.4 to 1.1. For example, the present green tea beverage packed in a container may be manufactured by preparing an extraction liquid, which is obtained by blowing hot water shower of 70° C. to 100° C. to tea leaves for 60 to 180 seconds to elute caffeine, and subjecting the tea leaves to a dry (firing) process at 280° C. to 330° C., and extracting the tea leaves at high temperature for a short time; an extraction liquid, which is obtained by preparing a conventional general green tea extraction liquid, that is, an extraction liquid that is obtained by subjecting tea leaves to a dry (firing) process at 80° C. to 150° C. and extracting the tea leaves at low temperature for a long time; and blending the extraction liquids in a suitable ratio. However, the manufacturing method is not limited to such manufacturing method.

Furthermore, as described above, if dry (firing) process of tea leaves is performed, reducing sugars decrease first, and then non-reducing sugars decrease. Therefore, the concentration of sugars and the value of non-reducing sugars/reducing sugars may be adjusted with adjustment of conditions for dry (firing) process.

### EXPLANATION FOR TERMS

The “green tea beverage” in the present invention means a beverage containing a tea extraction liquid or tea extract that is obtained from tea extraction, as a major component.

In addition, the “green tea beverage packed in a container” means a green tea beverage that is packaged in a container, and also means a green tea beverage that may be provided for drinking without dilution.

When “X to Y” (X and Y are any number) is expressed in the present specification, it encompasses the meaning of “X or more and Y or less”, and also the meaning of “preferably greater than X” and “preferably less than Y” unless otherwise stated.

### EXAMPLES

Hereinafter, Examples of the present invention will be explained. However, the present invention is not limited to these Examples.

Furthermore, the “concentration of reducing sugars” in Examples means a total concentration of glucose, fructose, cellobiose, and maltose, and the “concentration of non-reducing sugars” means a total concentration of sucrose, stachyose, and raffinose.

<Evaluation Test>

Extraction Liquids A to J described below were prepared, and using these Extraction Liquids, green tea beverages of Examples 1 to 3 and Comparative Examples 1 to 6 were prepared, and sensory evaluations therefor were performed.

(Extraction Liquid A)

Tea leaves (Yabukita species, first flush tea produced in Shizuoka Prefecture) after plucking were subjected to Aracha process, and to a dry process (firing process) under the conditions of 90° C. of the setting temperature and 30 minutes of the dry time with a rotation drum type drying machine. The tea leaves were extracted under the conditions of 5 g of the tea leaves, 1 L of 90° C. hot water and 3 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid A.

(Extraction Liquid B)

Tea leaves (Yabukita species, first flush tea produced in Shizuoka Prefecture) after plucking were subjected to Aracha process, and to a dry process (firing process) under the conditions of 90° C. of the setting temperature and 30 minutes of the dry time with a rotation drum type drying machine. The tea leaves were extracted under the conditions of 12 g of the tea leaves, 1 L of 70° C. warm water and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid B.

(Extraction Liquid C)

Tea leaves (Yabukita species, first flush tea produced in Shizuoka Prefecture) after plucking were subjected to Aracha process, and to a dry process (firing process) under the conditions of 280° C. of the setting temperature and 10 minutes of the dry time with a rotation drum type drying machine. The tea leaves were extracted under the conditions of 15 g of the tea leaves, 1 L of 90° C. hot water, and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction liquid C.

(Extraction Liquid D)

Tea leaves (Yabukita species, first flush tea produced in Shizuoka Prefecture) after plucking were subjected to Aracha process, and to a dry process (firing process) under the conditions of 280° C. of the setting temperature and 10 minutes of the dry time with a rotation drum type drying machine. The tea leaves were extracted under the conditions of 5 g of the tea leaves, 1 L of 90° C. hot water, and 3 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (5), to prepare Extraction liquid D.

(Extraction Liquid E)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 90° C. of the setting temperature and 30 minutes of the dry time with a rotation drum type drying machine. The tea leaves were extracted under the conditions of 5 g of the tea leaves, 1 L of 70° C. warm water, and 3 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m^{z} of the centrifugal sedimentation liquid area (Σ), to prepare Extraction liquid E.

(Extraction Liquid F)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 90° C. of the setting temperature and 30 minutes of the dry time with a rotation drum type drying machine. The tea leaves were extracted under the conditions of 12 g of the tea leaves, 1 L of 70° C. warm water, and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction liquid F.

(Extraction Liquid G)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 280° C. of the setting temperature and 10 minutes of the dry time with a rotation drum type drying machine. The tea leaves were extracted under the conditions of 15 g of the tea leaves, 1 L of 90° C. hot water, and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction liquid G.

(Extraction Liquid H)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 280° C. of the setting temperature and 10 minutes of the dry time with a rotation drum type drying machine. The tea leaves were extracted under the conditions of 5 g of the tea leaves, 1 L of 90° C. hot water, and 3 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (5), to prepare Extraction liquid H.

(Extraction Liquid I)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 290° C. of the setting temperature and 9 minutes of the dry time with a rotation drum type drying machine. The tea leaves were extracted under the conditions of 10 g of the tea leaves, 1 L of 90° C. hot water, and 6 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction liquid I.

(Extraction Liquid J)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 330° C. of the setting temperature and 1 minute of the dry time with a rotation drum type drying machine. The tea leaves were extracted under the conditions of 12 g of the tea leaves, 1 L of 90° C. hot water, and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction liquid J.

(Analysis of Extraction Liquids)

1/10 amount of each the above-described an extraction liquids was weighed, added with ascorbic acid in 400 ppm, and then added with sodium bicarbonate to adjust pH to 6.2, and added with ion-exchanged water to adjust the total amount to 100 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C. and measured for analysis of the components of each extraction liquid.

The results of the analyses are presented in Table 1 described below. Furthermore, the measurement method is as described below.

TABLE 1

| | Non- | | | | | | | | Amount |
|---|---|---|---|---|---|---|---|---|---|
| | reducing | | Ester | | | Soluble solid | | | of tea |
| | sugars/ | | type | | Total | content derived | Conditions | Extraction | leaves |
| | reducing | Sugars | catechins | Caffeine | catechins | from tea | for drying | time | used |
| | sugars | (ppm) | (ppm) | (ppm) | (ppm) | leaves (%) | (° C.) | (Minute) | (g/l) |
| Extraction | 1.62 | 80.3 | 103.9 | 45.1 | 209.9 | 0.11 | Firing at 90° C. | 3 | 5 |
| Liquid A | | | | | | | for 30 minutes | | |
| Extraction | 1.73 | 350.4 | 408.3 | 195.9 | 817.8 | 0.37 | Firing at 90° C. | 5 | 12 |
| Liquid B | | | | | | | for 30 minutes | | |
| Extraction | 27.60 | 335.2 | 311.4 | 235.8 | 629.1 | 0.53 | Firing at 280° C. | 5 | 15 |
| Liquid C | | | | | | | for 10 minutes | | |
| Extraction | 26.75 | 50.3 | 52.9 | 45.8 | 109.4 | 0.10 | Firing at 280° C. | 3 | 5 |
| Liquid D | | | | | | | for 10 minutes | | |
| Extraction | 1.79 | 79.6 | 58.9 | 15.8 | 118.9 | 0.10 | Firing at 90° C. | 3 | 5 |
| Liquid E | | | | | | | for 30 minutes | | |
| Extraction | 1.82 | 345.8 | 357.6 | 68.8 | 723.4 | 0.38 | Firing at 90° C. | 5 | 12 |
| Liquid F | | | | | | | for 30 minutes | | |
| Extraction | 27.76 | 332.8 | 279.2 | 82.5 | 564.0 | 0.48 | Firing at 280° C. | 5 | 15 |
| Liquid G | | | | | | | for 10 minutes | | |
| Extraction | 27.20 | 48.7 | 47.6 | 16.0 | 98.4 | 0.09 | Firing at 280° C. | 3 | 5 |
| Liquid H | | | | | | | for 10 minutes | | |
| Extraction | 16.78 | 215.4 | 256.7 | 56.4 | 529.8 | 0.21 | Firing at 290° C. | 6 | 10 |
| Liquid I | | | | | | | for 9 minutes | | |
| Extraction | 13.24 | 157.1 | 59.7 | 39.8 | 124.8 | 0.23 | Firing at 330° C. | 5 | 12 |
| Liquid J | | | | | | | for 1 minutes | | |

(Blending)

Extraction Liquids A to J were blended in the ratios presented in Table 2 described below, added with ascorbic acid in 400 ppm, and then added with sodium bicarbonate to adjust pH to 6.2, and added with ion-exchanged water to adjust the total amount to 1000 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C., to prepare the green tea beverages of Examples 1 to 3 and Comparative Examples 1 to 6.

TABLE 2

| | Example | Example | Example | Comparative | Comparative | Comparative | Comparative | Comparative | Comparative |
|---|---|---|---|---|---|---|---|---|---|
| | 1 | 2 | 3 | Example 1 | Example 2 | Example 3 | Example 4 | Example 5 | Example 6 |
| Extraction | 0 | 25 | 0 | 0 | 0 | 0 | 0 | 0 | 0 |
| Liquid A | | | | | | | | | |
| Extraction | 0 | 0 | 35 | 25 | 0 | 0 | 0 | 0 | 0 |
| Liquid B | | | | | | | | | |
| Extraction | 0 | 0 | 0 | 0 | 0 | 0 | 12 | 0 | 0 |
| Liquid C | | | | | | | | | |
| Extraction | 0 | 0 | 0 | 0 | 0 | 0 | 28 | 0 | 0 |
| Liquid D | | | | | | | | | |
| Extraction | 40 | 0 | 20 | 0 | 0 | 0 | 40 | 0 | 0 |
| Liquid E | | | | | | | | | |
| Extraction | 0 | 0 | 0 | 5 | 10 | 70 | 0 | 0 | 0 |
| Liquid F | | | | | | | | | |
| Extraction | 60 | 75 | 0 | 0 | 90 | 0 | 0 | 0 | 0 |
| Liquid G | | | | | | | | | |
| Extraction | 0 | 0 | 45 | 40 | 0 | 30 | 20 | 0 | 0 |
| Liquid H | | | | | | | | | |
| Extraction | 0 | 0 | 0 | 0 | 0 | 0 | 0 | 0 | 100 |
| Liquid I | | | | | | | | | |
| Extraction | 0 | 0 | 0 | 0 | 0 | 0 | 0 | 100 | 0 |
| Liquid J | | | | | | | | | |
| total | 100 | 100 | 100 | 100 | 100 | 100 | 100 | 100 | 100 |

### Analysis of Examples and Comparative Examples

Components of the green tea beverages of Examples 1 to 3 and Comparative Examples 1 to 6 were measured as described below. The results are presented in Table 3 described below.

TABLE 3

| | Example | Example | Example | Comparative | Comparative | Comparative | Comparative | Comparative | Comparative |
|---|---|---|---|---|---|---|---|---|---|
| | 1 | 2 | 3 | Example 1 | Example 2 | Example 3 | Example 4 | Example 5 | Example 6 |
| Non-Reducing | 17.37 | 21.23 | 13.20 | 119.5 | 25.17 | 9.43 | 16.96 | 13.24 | 16.78 |
| Sugar/Reducing | | | | | | | | | |
| Sugar | | | | | | | | | |
| Sugars (ppm) | 231.5 | 269.7 | 160.5 | 228.1 | 334.1 | 256.7 | 95.9 | 157.1 | 215.4 |
| Ester type | 191.1 | 235.4 | 176.1 | 246.3 | 287.0 | 264.6 | 85.3 | 59.7 | 256.7 |
| catechins (ppm) | | | | | | | | | |
| Caffeine (ppm) | 55.8 | 73.2 | 78.9 | 79.5 | 81.1 | 53.0 | 50.6 | 39.8 | 56.4 |
| pH | 6.2 | 6.2 | 6.2 | 6.2 | 6.2 | 6.2 | 6.2 | 6.2 | 6.2 |
| Ester type | 0.83 | 0.87 | 1.10 | 1.08 | 0.86 | 1.03 | 0.86 | 0.38 | 1.19 |
| catechins/Sugars | | | | | | | | | |
| Total catechins | 386.0 | 475.5 | 354.3 | 497.0 | 579.9 | 535.9 | 173.4 | 124.8 | 529.8 |
| (ppm) | | | | | | | | | |
| Soluble solid | 0.33 | 0.39 | 0.19 | 0.26 | 0.47 | 0.29 | 0.15 | 0.23 | 0.21 |
| content derived | | | | | | | | | |
| from tea | | | | | | | | | |
| leaves (%) | | | | | | | | | |
| Top aroma note | ⊚ | ⊚ | ◯ | Δ | ◯ | Δ | ⊚ | ◯ | ⊚ |
| Aroma remaining | ⊚ | ◯ | ◯ | Δ | Δ | X | Δ | ◯ | Δ |
| in aftertaste | | | | | | | | | |
| Concentration | ⊚ | ⊚ | ◯ | Δ | Δ | Δ | X | Δ | ◯ |
| feeling | | | | | | | | | |
| Goodness of | ⊚ | ◯ | Δ | Δ | X | Δ | ◯ | X | X |
| aftertaste | | | | | | | | | |
| Color tone | ◯ | Δ | ◯ | ◯ | X | ◯ | ◯ | ◯ | ◯ |
| (redness and | | | | | | | | | |
| the like) | | | | | | | | | |
| Total Evaluation | ⊚ | ◯ | ◯ | Δ | X | X | X | Δ | Δ |

The concentration of reducing sugars and the concentration of non-reducing sugars were quantity-measured by a calibration curve method with manipulation of a HPLC sugar analysis equipment (manufactured by Dionex Corporation) under the conditions described below.

Column: Carbopack PA1 φ4.6×250 mm manufactured by Dionex Corporation

Column temperature: 30° C.

Mobile Phase:
Phase A 200 mM NaOH
Phase B 1000 mM Sodium Acetate
Phase C Ultrapure water

Flow Rate: 1.0 mL/min

Injection Amount: 25 μL

Detection: ED50 gold electrode manufactured by Dionex Corporation

The concentration of ester type catechins, the concentration of total catechins, and the concentration of caffeine were quantity-measured by a calibration curve method with manipulation of a high performance liquid chromatogram (HPLC) under the conditions described below.

Column: Xbridge shield RP18 φ3.5×150 mm manufactured by Waters Corporation

Column Temperature: 40° C.

Mobile Phase:
Phase A Water
Phase B Acetonitrile
Phase C 1% phosphoric acid

Flow Rate: 0.5 mL/min

Injection Amount: 5 μL

Detection: UV230 nm UV detector manufactured by Waters Corporation

The pH was measured with F-24, a pH meter manufactured by HORIBA, Ltd.

An extraction liquid containing only extract of tea leaves was diluted to 1 L of the liquid amount, and the concentration of the soluble solid content derived from tea leaves was measured with a differential concentration meter DD-7 manufactured by ATAGO CO., Ltd.

(Evaluation Item)

Using the green tea beverages of Examples 1 to 3 and Comparative Examples 1 to 6, the top aroma note, the aroma remaining in the aftertaste note, the concentration feeling, the goodness of aftertaste, and the color tone (redness or the like) were evaluated.

(Evaluation Test)

The green tea beverages of Examples 1 to 3 and Comparative Examples 1 to 6 were cooled to 5° C. in a refrigerator. Each of the green tea beverages was first visually observed by five people of trained examiners. Then, the green tea beverages were tasted, and given scores by the standards as described below. The average points of the five people were evaluated such that “⊚ (double circle)” indicates 3.5 or more, “∘ (circle)” indicates 3 or more and less than 3.5, “Δ (triangle)” indicates 2 or more and less than 3, and “x (cross)” indicates 1 or more and less than 2. The results thereof are presented in Table 3 described above.

<Top Aroma Note>

Particularly Strong=4

Strong=3

Somewhat=2

Usual=1

<Aroma Remaining in the Aftertaste Note>

Particularly Good=4

Good=3

Somewhat=2

Not sensed=1

<Concentration Feeling>

Particularly Strong=4

Strong=3

Somewhat=2

Week=1

<Goodness of Aftertaste>

Particularly Good=4

Good=3

Usual=2

Bad=1

<Color Tone (Redness or the Like)>

Particularly Good=4

Good=3

Slightly Red=2

Red=1

(Total Evaluation)

The average points of the above-described five evaluation tests were computed, and the evaluations were performed which are “⊚ (double circle)” indicates 3.5 or more, “∘ (circle)” indicates 3 or more and less than 3.5, “Δ(triangle)” indicates 2 or more and less than 3, and “x (cross)” indicates 1 or more and less than 2 of the average point.

For any of Examples 1 to 3, excellent results were obtained, of which the total evaluation was “∘ (circle)” or better.

On the other hand, for Comparative Examples 1 to 6, the results were not preferable, in which the evaluation was “Δ (triangle)” for Comparative Examples 1, 5 and 6, and “x (cross)” for Comparative Examples 2 to 4.

(Discussion)

From the results of Comparative Example 4, it was found out that if the concentration of sugars decreases, mainly concentration feeling disappears. From the results of Comparative Example 2, it was found out that if the concentration of sugars increases, mainly aftertaste and color tone become worse.

From the results of Comparative Example 2, it was found out that if the value of non-reducing sugars/reducing sugars increases, mainly aftertaste and color tone become worse. From the results of Comparative Examples 1 and 3, it was found out that if the value of non-reducing sugars/reducing sugars decreases, top aroma note and aroma remaining in the aftertaste become worse.

From the results of Comparative Examples 5 and 6, it was found out that if the value of ester type catechins/sugars increases or decreases, mainly aftertaste becomes worse.

From these results, it is assumed that the ranges of the concentration of sugars which is a sum of the concentration of non-reducing sugars and the concentration of reducing sugars being 100 ppm to 300 ppm, the ratio of the concentration of non-reducing sugars relative to the concentration of reducing sugars (non-reducing sugars/reducing sugars) being 13.0 to 23.0, and the ratio of the concentration of ester type catechins relative to the concentration of sugars (ester type catechins/sugars) being 0.4 to 1.1 when the concentration of caffeine is set to less than 90 ppm, are ranges that allow good top aroma note, aroma remaining in the aftertaste note, concentration feeling, goodness of aftertaste, and color tone (redness or the like). It was discovered that a green tea beverage having them within such ranges provide a green tea beverage packed in a container that has concentration feeling from fire odor (savory odor), and has richness of astringent taste, and refreshing taste even in a cold state.

1. A green tea beverage packed in a container wherein,
a concentration of caffeine is less than 90 ppm;
a concentration of sugars, a sum of the concentration of non-reducing sugars and the concentration of reducing sugars is 100 ppm to 300 ppm;
a ratio of the concentration of non-reducing sugars relative to the concentration of reducing sugars (non-reducing sugars/reducing sugars) is 13.0 to 23.0; and,
a ratio of the concentration of ester type catechins relative to the concentration of sugars (ester type catechins/sugars) is 0.4 to 1.1.

2. A method of preparing a green tea beverage packed in a container, comprising;
adjusting a concentration of caffeine in a green tea beverage to less than 90 ppm;
adjusting a concentration of sugars, a sum of a concentration of non-reducing sugars and a concentration of reducing sugars to 100 ppm to 300 ppm;
adjusting a ratio of the concentration of non-reducing sugars relative to a concentration of reducing sugars (non-reducing sugars/reducing sugars) to 13.0 to 23.0; and,
adjusting a ratio of the concentration of ester type catechins relative to a concentration of sugars (ester type catechins/sugars) to 0.4 to 1.1.

2. A method of improving a flavor of a green tea beverage packed in a container, comprising;
adjusting a concentration of caffeine in a green tea beverage to less than 90 ppm;
adjusting a concentration of sugars, a sum of a concentration of non-reducing sugars and a concentration of reducing sugars to 100 ppm to 300 ppm;
adjusting a ratio of a concentration of non-reducing sugars relative to a concentration of reducing sugars (non-reducing sugars/reducing sugars) to 13.0 to 23.0; and,
adjusting a ratio of a concentration of ester type catechins relative to a concentration of sugars (ester type catechins/sugars) to 0.4 to 1.1.
